(19) United States
(12) Patent Application Publication
(10) Pub. No.: US 2026/0220408 A1
(43) Pub. Date: Jul. 30, 2026

(54) STORAGE MEDIUM STORING PROGRAM, INFORMATION PROCESSING APPARATUS, AND LABEL DATA SHARING SYSTEM

(71) Applicant: BROTHER KOGYO KABUSHIKI KAISHA, Nagoya (JP)

(72) Inventors: Fuyuko ITO, Yokkaichi (JP); Jun YAMADA, Nagoya (JP); Aiko YASUI, Nagoya (JP); Ryoji BAN, Kiyosu (JP); Katsumi KIYOSE, Nagoya (JP); Tetsuya NOSE, Nagoya (JP)

(21) Appl. No.: 19/629,693

(22) Filed: Mar. 26, 2026

Related U.S. Application Data
(63) Continuation of application No. PCT/JP2024/028035, filed on Aug. 6, 2024.

(30) Foreign Application Priority Data
Sep. 29, 2023 (JP) 2023-169349

(51) Int. Cl. G06K 15/02; B41J 3/407

(52) U.S. Cl. CPC G06K 15/1805; B41J 3/4075

(57) ABSTRACT

A non-transitory computer-readable storage medium stores a set of program instructions for an information processing apparatus including a controller and a memory. The set of program instructions, when executed by the controller, causes the information processing apparatus to perform editing label data, the label data being printable by a label printer, storing the edited label data in the memory, controlling the label printer to perform printing based on the edited label data or the stored label data, in response to storing the label data or performing printing based on the label data, suggesting posting of the stored label data or the printed label data, and posting the label data, the posting the label data including uploading the label data to a server. The server is configured to store the uploaded label data.

### REFERENCE TO RELATED APPLICATIONS

This is a Continuation Application of International Application No. PCT/JP2024/028035 filed on August 6, 2024, which claims priority from Japanese Patent Application No. 2023-169349 filed on September 29, 2023. The entire content of each of the prior applications is incorporated herein by reference.

### BACKGROUND ART

A server for storing various content data is known.

### SUMMARY

A system for utilizing content data includes a server on the Internet that stores content data, where users upload content from their devices to the server, and other users download the content data from the server to their devices.

A point management system is disclosed in which photo data uploaded from User A's PC to a WWW server is purchased and downloaded by User B's PC. Upon download, User B, the purchaser, is awarded points corresponding to the purchase amount. Further, User A, the uploader, receives points based on data size of photo data either at the time of upload or download.

Recently, systems have been suggested in which users upload label data used for label printing on label printers to a server, allowing other users to download the label data from the server for use. In such systems, many users are encouraged to post (upload) label data.

In view of the foregoing, an example of an object of this disclosure is to a storage medium storing a program, an information processing apparatus, and a label data sharing system configured to promote posting (upload) of content such as photo data.

According to one aspect, this specification discloses a non-transitory computer-readable storage medium storing a set of program instructions for an information processing apparatus including a controller and a memory. The set of program instructions, when executed by the controller, causes the information processing apparatus to perform editing label data. The label data is printable by a label printer. Thus, the label data is edited. The set of program instructions, when executed by the controller, causes the information processing apparatus to perform storing the edited label data in the memory. Thus, the edited label data is stored in the memory. The set of program instructions, when executed by the controller, causes the information processing apparatus to perform controlling the label printer to perform printing based on the edited label data or the stored label data. Thus, the label data is printed by the label printer. The set of program instructions, when executed by the controller, causes the information processing apparatus to perform, in response to storing the label data or performing printing based on the label data, suggesting posting of the stored label data or the printed label data. Thus, posting of the label data is suggested. The set of program instructions, when executed by the controller, causes the information processing apparatus to perform posting the label data. The posting the label data includes uploading the label data to a server, and the server is configured to store the uploaded label data. Thus, the label data is posted and stored in the server.

According to the storage medium storing the program disclosed herein, the information processing apparatus suggests posting of the label data when the label data is stored or printed. Storing or printing the label data indicates that editing is likely complete. Therefore, suggesting posting the processed label data upon storing or printing increases the likelihood of the label data being posted.

An information processing apparatus incorporating the above program, a system including the information processing apparatus, a control method for implementing the functions of the program, and a computer-readable storage medium storing the program are all novel and useful.

According to the technology disclosed herein, a system utilizing label data promotes posting of label data.

### BRIEF DESCRIPTION OF DRAWINGS

FIG. 1 is a schematic diagram of a system.

FIG. 2 is a sequence diagram illustrating a posting suggestion procedure of label data.

FIGS. 3A, 3B and 3C illustrate examples of editing screens.

FIG. 4 is a flowchart illustrating an automatic editing process.

FIGS. 5A, 5B, 5C and 5D illustrate examples of automatic editing of label data.

FIG. 6 is a sequence diagram illustrating a posting procedure.

FIGS. 7A and 7B illustrate examples of posting screens.

FIG. 8 is a sequence diagram illustrating a download procedure.

FIG. 9 is a sequence diagram illustrating an instruction acceptance procedure.

FIG. 10 illustrates an example of a selection screen.

FIG. 11 is a sequence diagram illustrating a server editing procedure.

### DESCRIPTION

An embodiment of a label data sharing system is described in detail below with reference to the accompanying drawings. This specification discloses a system in which a server and a plurality of information processing apparatuses are connected via a network to enable sharing of label data used for printing labels on label printers.

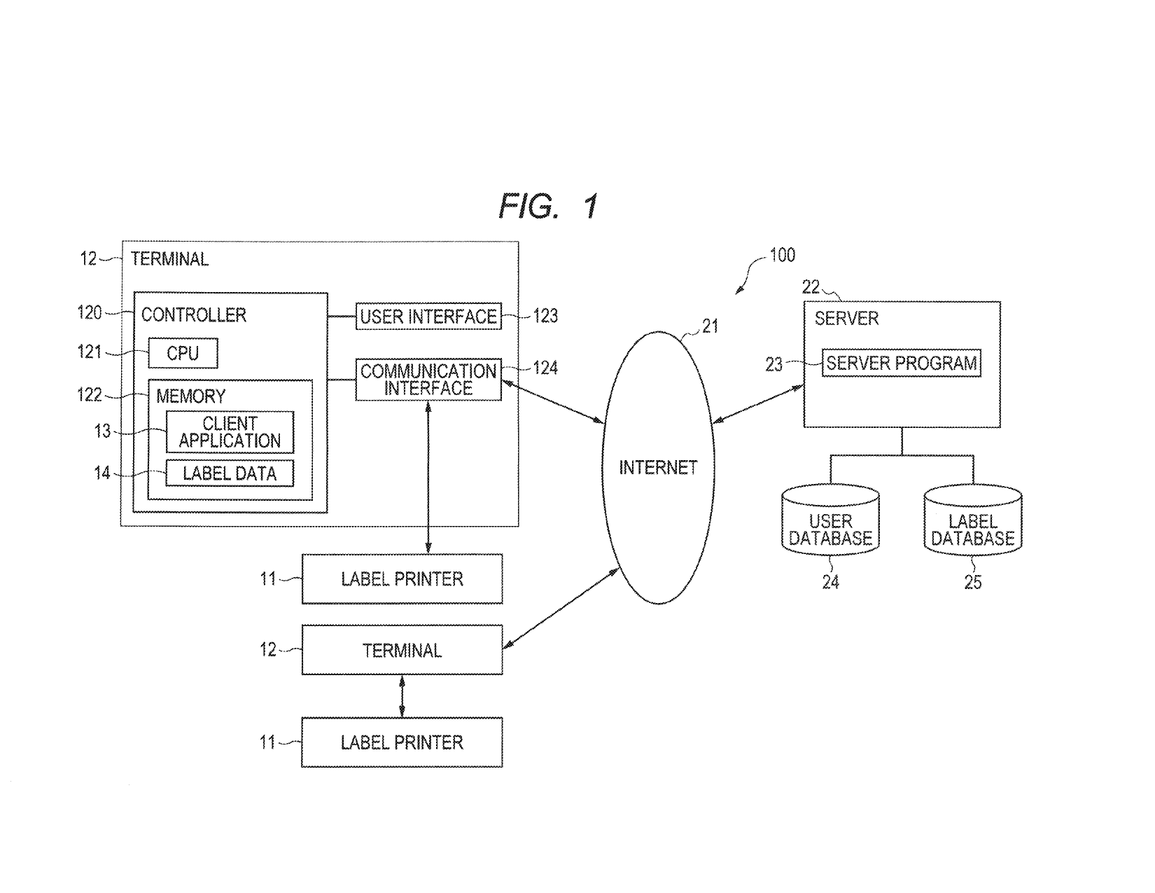

As shown in FIG. 1, a label data sharing system 100 (hereinafter "system 100") of this embodiment is provided to users, for example, by a vendor of a label printer 11. The system 100 includes a plurality of terminals 12 and a server 22, connected via Internet 21. Each terminal 12 is connectable to at least one label printer 11. The Internet 21 is an example of a network.

The terminal 12 is an apparatus having a communication function, a display function, and a user operation acceptance function (input function). As shown in FIG. 1, the terminal 12 includes a controller 120 including a CPU 121 and a memory 122. The terminal 12 is an example of an information processing apparatus, and the CPU 121 is an example of a computer (controller). The terminal 12 also includes a user interface 123 and a communication interface 124, both electrically connected to the controller 120. As shown in FIG. 1, the controller 120 collectively represents hardware and software used to control the terminal 12 and does not necessarily correspond to a single hardware component. The terminal 12 may be a portable device such as a smartphone or tablet computer, or a personal computer.

The user interface 123 includes hardware for displaying a screen that notifies information to the user and hardware for accepting user operations. The user interface 123 may include a combination of a display capable of presenting information and input devices such as a mouse or keyboard for accepting operations, or may be a touch panel that integrates both display and operation acceptance (input) functions.

The communication interface 124 includes hardware for communication with external devices such as the label printer 11 and server 22. The communication standards of the communication interface 124 include Ethernet, Wi-Fi, and USB. The terminal 12 may include a plurality of communication interfaces 124 supporting various communication standards. The "Wi-Fi" is a registered trademark of Wi-Fi Alliance.

The memory 122 of each terminal 12 stores a client application program (hereinafter, "client application") 13. The client application 13 is an example of a program. Each terminal 12 is also capable of storing label data 14. The label data 14 is data printable by the label printer 11 and is created using the client application 13.

The client application 13 is a software program provided by the vendor of the label printer 11. The client application 13 includes various functions, such as an editing function that allows the terminal 12 to create and edit the label data 14 based on user instructions, a saving function that stores the created label data 14 in the memory 122 of the terminal 12, and a printing function that transmits the created label data 14 to the label printer 11 for printing.

The label printer 11 is a printing device including a thermal transfer print head, which prints on rolled label sheet while feeding the paper. The label printer 11 prints an image on the label sheet based on label data received from the terminal 12 and feeds the label sheet to cause the printed portion to protrude outside the device. The label printer 11 communicates with the terminal 12 via wireless LAN such as Wi-Fi or short-range wireless communication such as Bluetooth. Alternatively, the label printer 11 may communicate with the terminal 12 through wired communication based on the USB standard. The "Bluetooth" is a registered trademark of Bluetooth SIG, Inc.

The server 22 is a device including at least a storage function and a communication function. The server 22 incorporates a server program 23. The server 22 accesses a user database 24 and a label database 25. The user database 24 stores user information representing users of the system 100. The label database 25 is a database that stores label data.

The user of the terminal 12 uses the system 100 to share the label data 14 created by using the client application 13. The server program 23 accepts instructions via the client application 13 to upload the label data 14 created on the terminal 12 to the server 22 and to download label data stored (registered) in the label database 25 to the terminal 12. In this specification, uploading to the server 22 is also referred to as "posting."

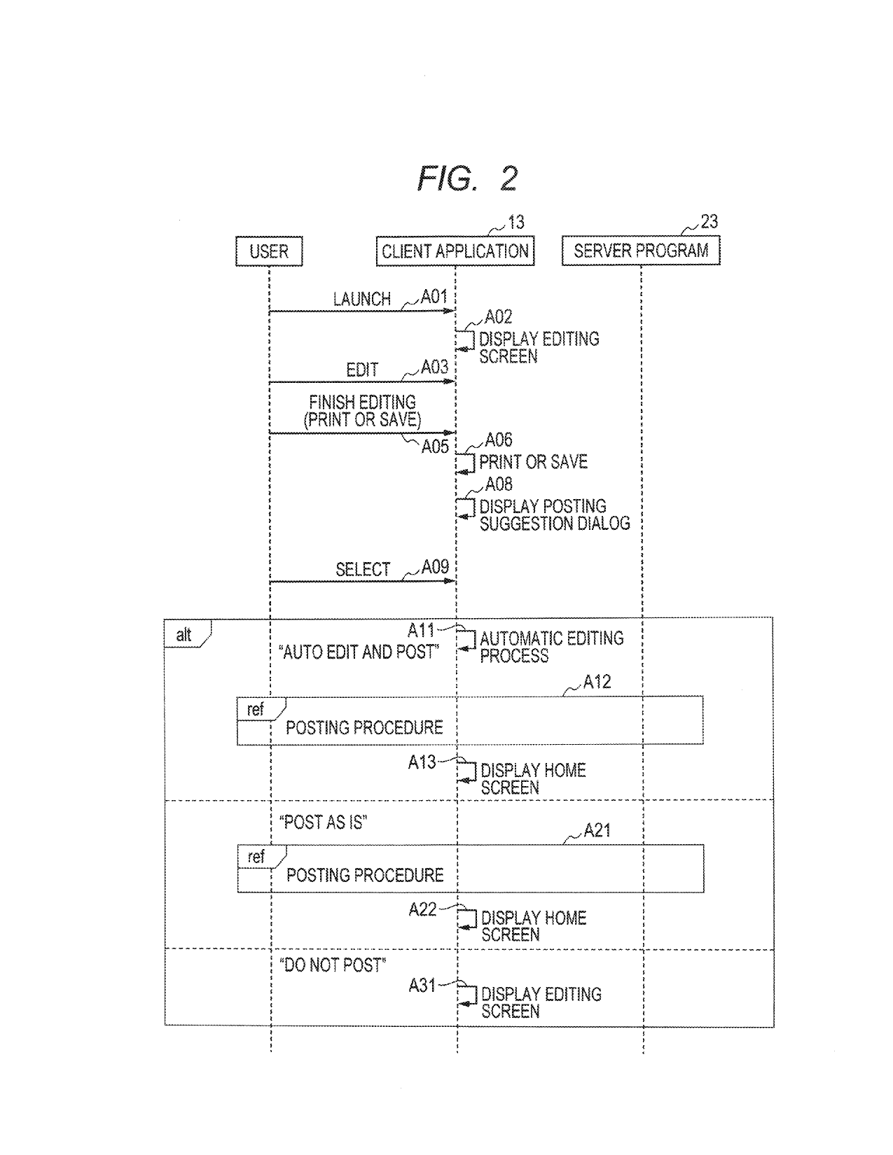

Next, with reference to the sequence diagram of FIG. 2, a procedure for suggesting posting of the label data 14 by the terminal 12 in the system 100 will be described. The steps and processes of each program described below represent operations executed by the CPU 121 of the terminal 12 and the CPU of the server 22 according to the instructions described in the respective programs. These CPU operations include hardware control using API of the operating system. In this specification, descriptions of the operating system are omitted in describing the operation of each program.

In the system 100 of this embodiment, the user first launches the client application 13 on the terminal 12 (A01). After launch, the client application 13 displays an editing screen for editing label data on the user interface 123 of the terminal 12 based on the user's operation (A02). The user edits the label data on the displayed editing screen (A03).

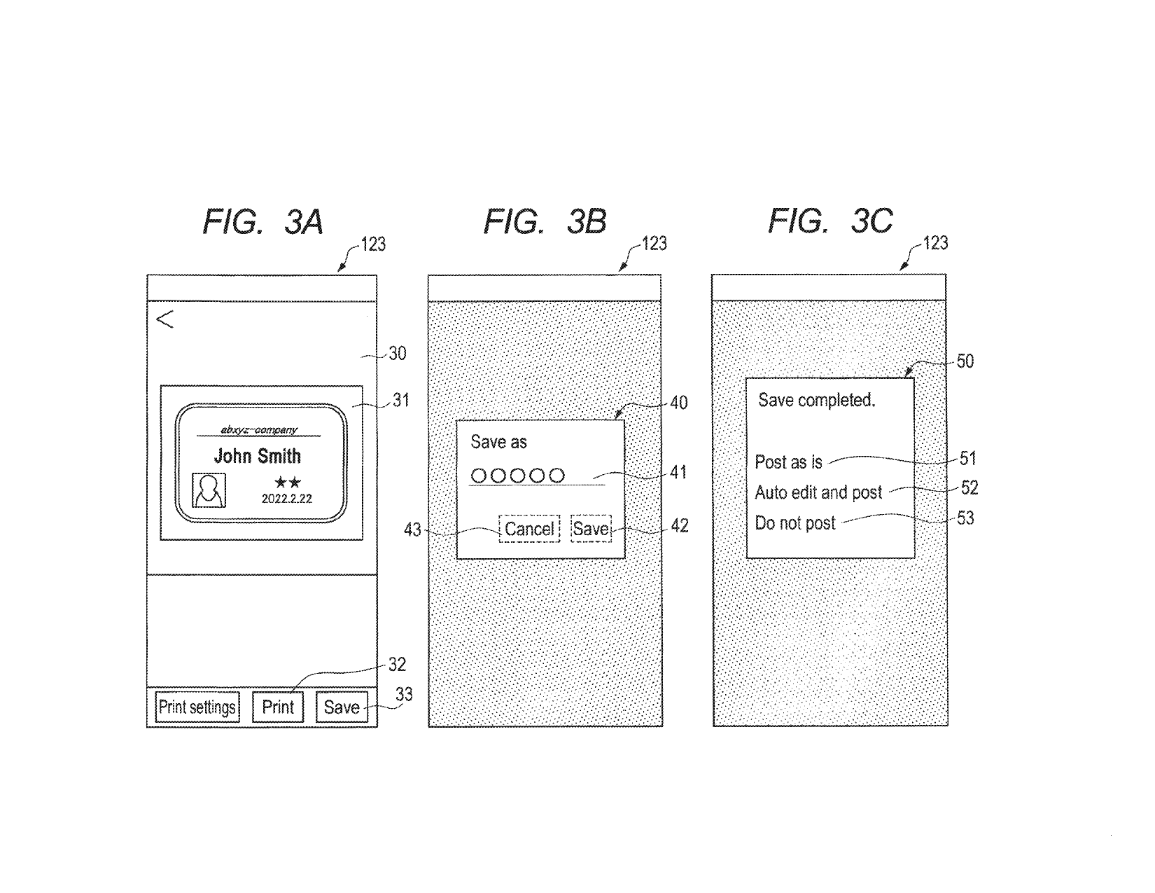

For example, as shown in FIG. 3A, an editing screen 30 includes a label image display area 31 that displays an image of a label based on label data that is being edited. The client application 13 accepts editing operations on the label data displayed in the label image display area 31 of the editing screen 30. Such editing operations include, for example, pasting objects, inserting data to be printed into objects, and changing the arrangement or size of objects. The editing screen 30 also includes a print button 32 for accepting a print command based on the displayed label data, and a save button 33 for accepting a save instruction for the displayed label data.

After editing the label data, the user instructs printing or saving the completed label data by operating the print button 32 or the save button 33, as shown in FIG. 3A (A05). Based on the user's instruction, the client application 13 performs a process of printing or saving (A06). For example, when a print instruction is accepted in A05, the client application 13, in A06, sends the displayed label data to the label printer 11 as print data and causes the label printer 11 to print according to the label data. The processing in A06 upon accepting a print instruction in A05 is an example of a printing process.

Upon accepting a save instruction in A05, the client application 13 starts a process of saving the currently displayed label data. As shown in FIG. 3B, the client application 13 disables input to the editing screen 30 and displays a save dialog 40 on the user interface 123. The save dialog 40 includes an input field 41 for entering the filename, a save confirmation button 42 to accept a save instruction, and a cancel button 43 to cancel a save operation. The client application 13 waits until either the save confirmation button 42 or the cancel button 43 is pressed.

When the save confirmation button 42 in the save dialog 40 is operated, the client application 13 stores the label data displayed on the editing screen 30 at the time of accepting the save instruction into the memory 122. The processing of A06 in this case is an example of a save process. When the cancel button 43 is operated, the client application 13 closes the save dialog 40 and returns to the editing screen 30.

Upon completion of printing or saving label data, the client application 13 displays a posting suggestion dialog on the user interface 123 of the terminal 12 (A08). Step A08 is an example of a suggestion process. The post suggestion dialog displayed after saving the label data includes, as shown in FIG. 3C, a message indicating the completion of saving and buttons for user selection. The post suggestion dialog displayed after accepting a print instruction may include a message indicating that print data has been sent to the label printer 11.

In A08, the client application 13 displays a posting suggestion dialog 50 on the user interface 123, as shown in FIG. 3C, prompting the user to choose whether to post. The posting suggestion dialog 50 includes buttons for user selection, such as a "Post as is" button 51, an "Auto edit and post" button 52, and a "Do not post" button 53. The client application 13 waits until one of the buttons 51, 52, or 53 is operated.

The user selects whether to post by operating one of the buttons 51, 52, or 53 included in the posting suggestion dialog 50 (A09). The "Post as is" button 51 accepts an instruction to post the label data, which is the subject of printing or saving, without any changes. The "Auto edit and post" button 52 accepts an instruction to automatically change the label data to a particular content and post the changed data. The "Do not post" button 53 accepts an instruction not to post the label data.

First, an automatic editing process will be described. When an instruction to automatically edit and post is accepted, specifically upon an operation of the button 52 (alt: [Auto edit and post]), the client application 13 executes the automatic editing process (A11). The operation of the button 52 serves as an example of an instruction to change the content of a particular object included in the label data of the suggestion target to a particular content and then post the changed label data. The label data of the suggestion target is the label data that has been printed or saved in A06.

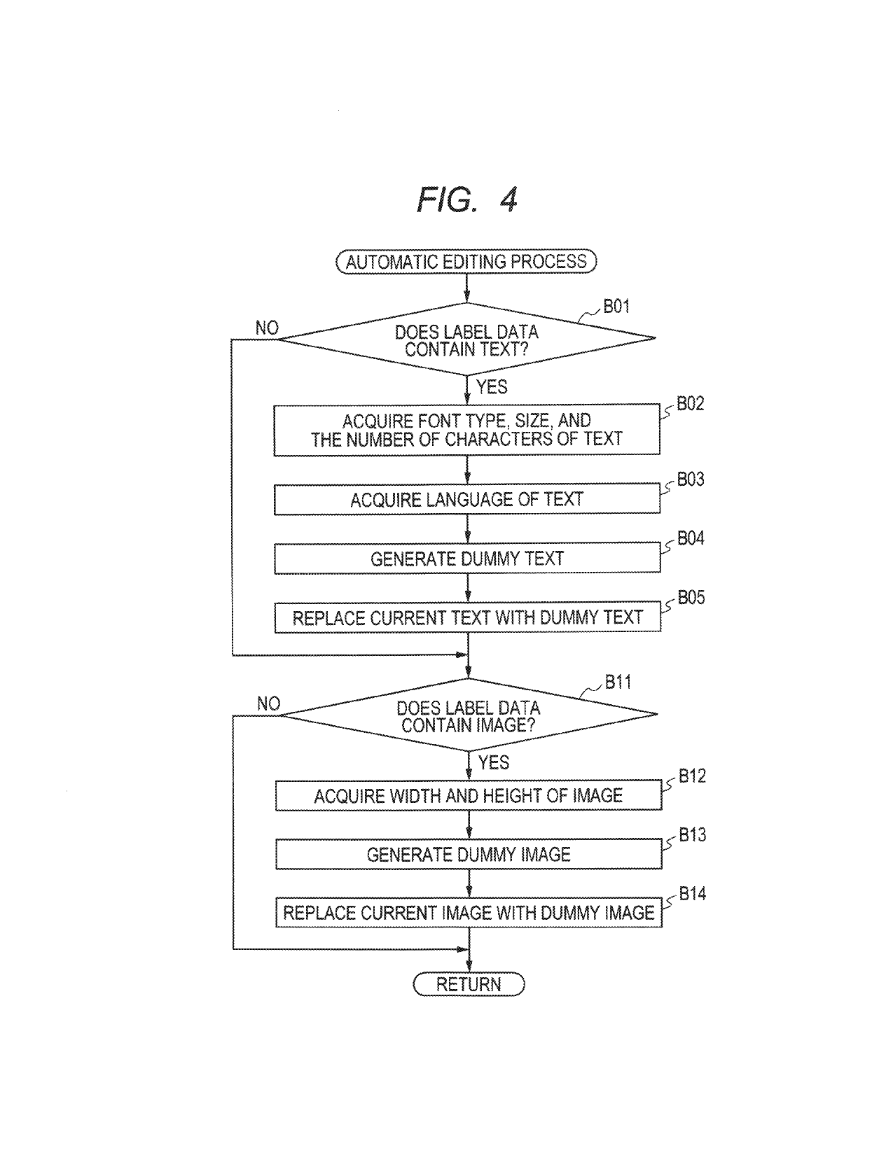

The automatic editing process is a process of extracting text objects and image objects from the label data of the suggestion target and replaces its content with dummy text or images. The procedure of the automatic editing process is described with reference to the flowchart in FIG. 4. The automatic editing process is executed by the CPU 121 of the terminal 12 based on descriptions of the client application 13.

The CPU 121 first determines whether the label data of the suggestion target includes a text object (B01). A text object is an example of a particular object subject to change. The text object is an object that is editable by accepting user's input on the label data editing screen shown in FIG. 3A. Thus, the text represented by the text object is user-entered or edited, and may include user's personal information such as the user's name or contact details.

In response to determining that the label data includes a text object (B01: YES), the CPU 121 acquires information about the text indicated by the text object, such as font type, font size, and the number of characters (B02). This information is included in the text object as supplementary information.

Further, the CPU 121 acquires the language of the text indicated by the text object (B03). For example, the CPU 121 may acquire the language used by querying the OS of the terminal 12. In a case where the client application 13 allows setting the language, the CPU 121 acquires the language set in the client application 13. The CPU 121 may also determine the language based on the font type acquired in B02.

Based on the information acquired in B02 and B03, the CPU 121 generates dummy text (B04) and replaces the text object in the label data with a text object containing the dummy text (B05). Step B05 is an example of a change process. The dummy text is an example of a particular text. Specifically, the CPU 121 replaces the text shown in the text object of the label data with particular dummy text. By changing the text in the text object to the particular text, label data for posting that does not contain personal information is generated.

The client application 13 may store, for each language, a particular sample character string consisting of one or more characters used as dummy text. The CPU 121 generates dummy text by creating a string of characters in the language acquired in B03, using the font type and size acquired in B02, with the number of characters also acquired in B02. By arranging the same number of characters in the same font type and size as those in the original text object, the visual difference in the label before and after the change is minimized.

The CPU 121 may repeat the sample character string until the number of characters matches the number of characters of the text object in a case where the text object contains more characters than the sample character string. In a case where the text object contains fewer characters than the sample character string, the CPU 121 may use a substring of the sample character string, matching the number of characters of the text object, as dummy text.

The sample character string used as dummy text does not contain any user personal information. For example, the sample character string may be a dummy character string such as "sample" or "test," a repetition of the same character, or a character string that is commonly used for test print in the relevant language. The sample character string may also be characters that are randomly selected by the CPU 121 or a character string unrelated to the user, such as the vendor's name of the label printer 11.

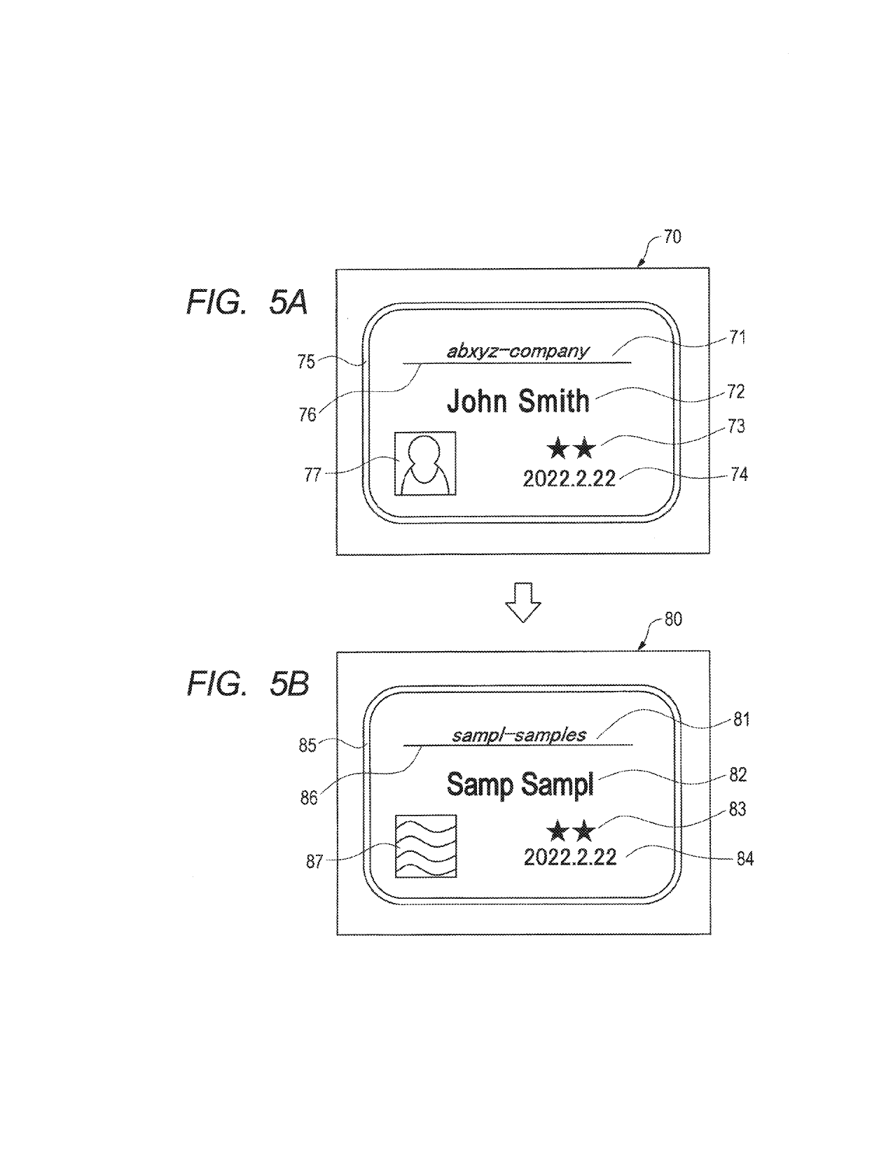

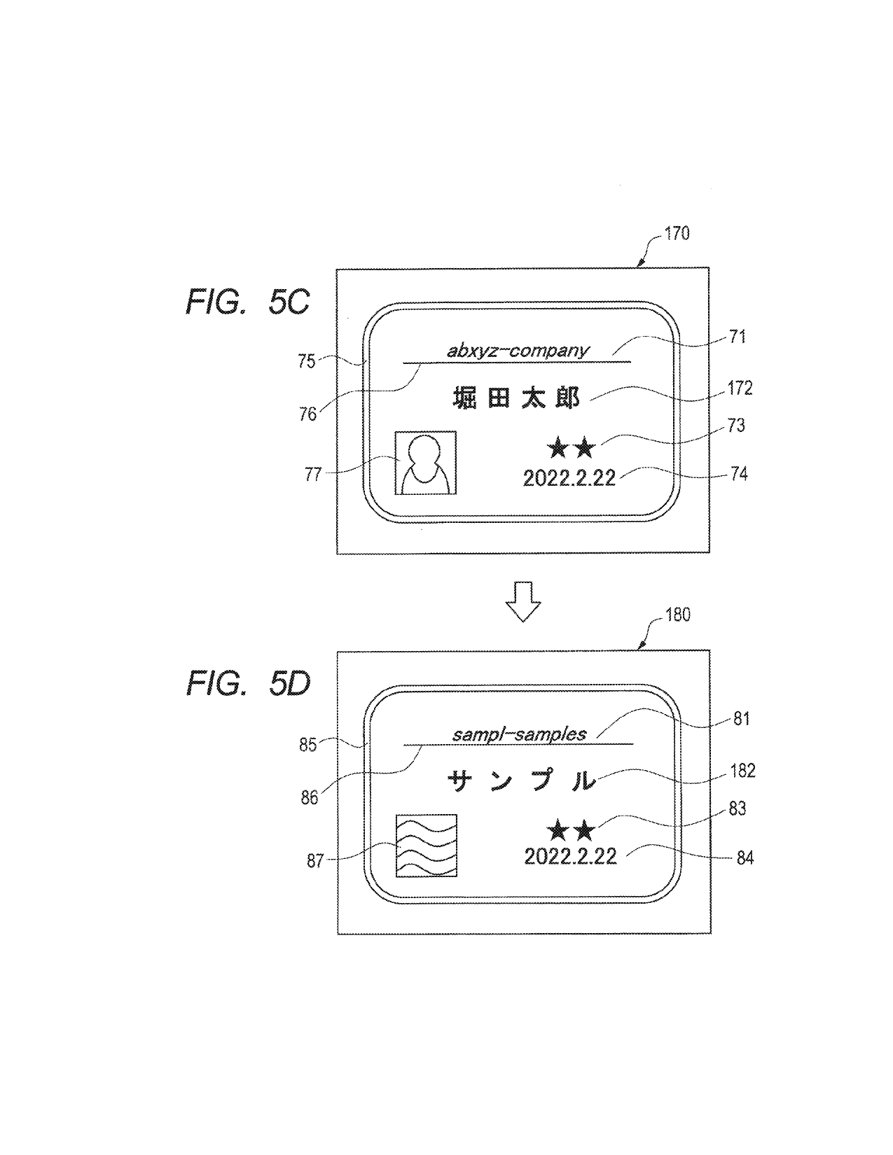

In a case where the label data includes a plurality of text objects, the CPU 121 executes B02 to B05 for each text object. For example, italic Latin text 71 in label data 70 shown in FIG. 5A is replaced with dummy text 81 in the same italic Latin font, as shown in FIG. 5B. Similarly, the bold Latin text 72 in the label data 70 shown in FIG. 5A is replaced with dummy text 82 in the same bold Latin font, as shown in FIG. 5B. In another example shown in FIGS. 5C and 5D, bold Japanese text 172 (four Japanese characters representing a person's name "Horita Taro") in label data 170 shown in FIG. 5C is replaced with dummy text 182 (four Japanese characters meaning "sample") in the same bold Japanese font, as shown in edited label data 180 in FIG. 5D. The client application 13 may store both the Japanese word meaning "sample" for Japanese text and the English word "sample" for Latin text as sample character strings in a case where the language is Japanese.

The client application 13 may determine whether the text contained in the text object is a common noun. In response to determining that the text is a common noun, the client application 13 may opt not to replace the text with dummy text. When the text includes symbols, the CPU 121 may choose not to change the symbols. Additionally, the client application 13 may prepare a plurality of sample character strings associated with respective categories and generate dummy text using a string from the same category as that of the text indicated in the text object.

After B05, or in response to determining that the label data of the suggestion target does not contain a text object (B01: NO), CPU 121 determines whether the label data includes an image object (B11). The image object is an example of a particular object subject to change. The image object is an object that is editable by accepting user's operations on the editing screen for label data, as shown in FIG. 3A. In other words, an image contained in the image object is selected by the user and may include personal information such as photographs of the user or their family members.

In response to determining that the label data includes an image object (B11: YES), the CPU 121 acquires the vertical and horizontal dimensions (height and width) of the image object (B12). Then, the CPU 121 generates a dummy image representing particular content according to the acquired dimensions (B13) and replaces the image object with the dummy image (B14). Step B14 is an example of a change process. The dummy image is an example of a particular image.

The client application 13 may include a sample image for generating dummy images. The sample image represents particular content that does not contain any personal information of the user. For example, the sample image may be a solid color, contain meaningless patterns, or include images unrelated to the user, such as the logo of the label printer 11 vendor. The CPU 121 adjusts the preliminarily prepared sample image to match the size of the image object in the label data, thereby generating the dummy image.

The client application 13 may select, as a dummy image, a sample image of the closest size from among a plurality of sample images of different sizes. The client application 13 may trim a sample image to generate a dummy image in a case where the sample image is larger than the image object in the label data. The client application 13 may enlarge or reduce a sample image to generate a dummy image of the same size as the image object in the label data.

For example, an image object 77 containing the photo image of the label data 70 shown in FIG. 5A is replaced with a dummy image object 87 as shown in FIG. 5B. By replacing the image object with a dummy image, label data suitable for posting without personal information is generated. Additionally, changing to a dummy image matching the size of the original image object minimizes the visual difference before and after change. When the label data includes a plurality of image objects, the CPU 121 executes B12 to B14 for all image objects.

The client application 13 may prepare a plurality of sample images associated with respective categories and generate dummy images by selecting sample images matching the category of the image of the label data. The client application 13 may prepare color and monochrome sample images and generate dummy images by selecting sample images according to the color of the image of the label data. The client application 13 may generate dummy images by filling the image object with one or more colors contained in the image object of the label data. The client application 13 may generate dummy images by applying a blur process to the image object.

The CPU 121 may also change objects other than text and image objects. For example, in a case where the label data to be suggested includes paid content, the CPU 121 may replace the paid content with free content.

Alternatively, the CPU 121 may leave objects other than text and image objects unchanged. For example, among the label data 70 shown in FIG. 5A, the CPU 121 may leave a clip art 73, a date-time object 74, a frame object 75, and a shape object 76 unchanged. In this case, as shown in FIG. 5B, edited label data 80 after automatic editing includes a clip art 83, a date-time object 84, a frame object 85, and a shape object 86 which are the same as before the automatic editing.

After B14, or in response to determining that the label data for the suggestion does not include an image object (B11: NO), the CPU 121 ends the automatic editing process and returns to the posting suggestion procedure shown in FIG. 2.

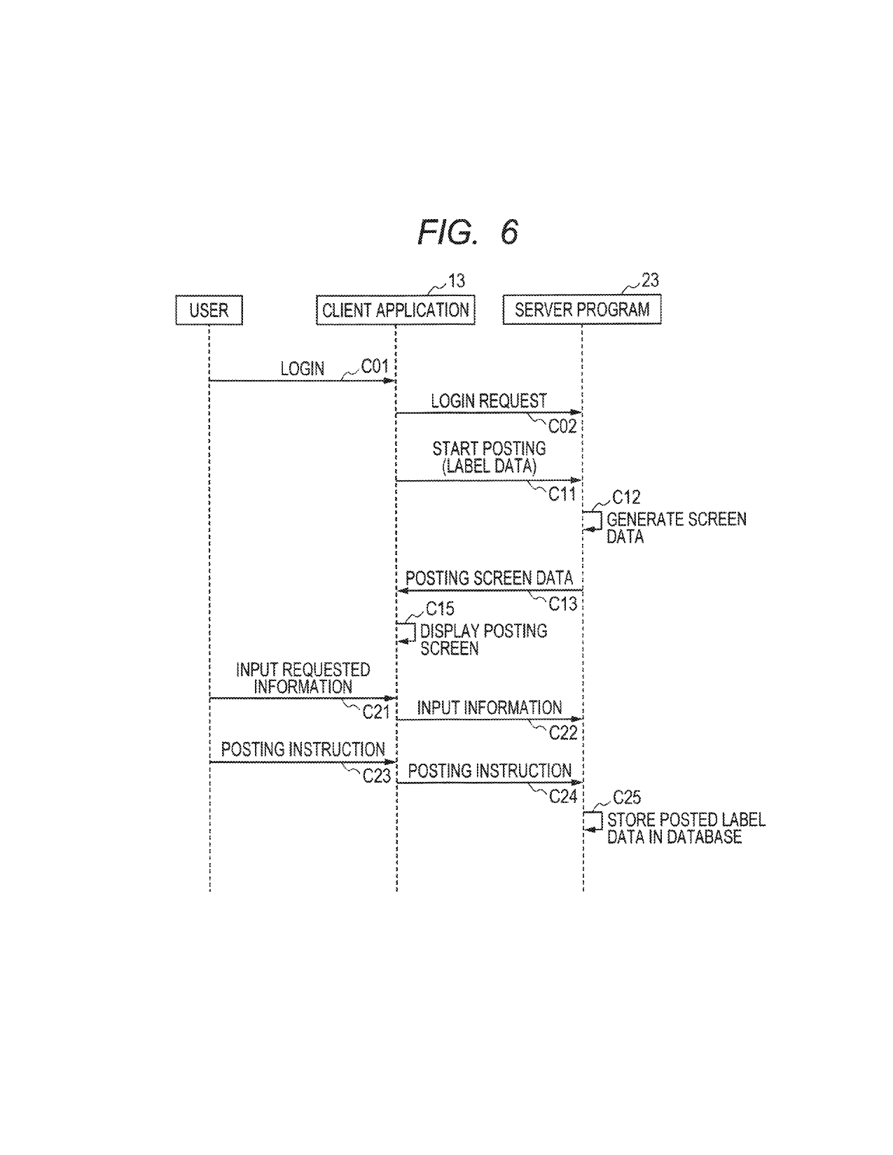

Referring to the posting suggestion procedure in FIG. 2, after the automatic editing process A11, the client application 13 starts a posting procedure A12 successively without requiring any user operation to start the posting. The posting procedure is described with reference to the sequence diagram in FIG. 6.

In the posting procedure, the client application 13 accepts user login (C01). The client application 13 displays a login screen on the user interface 123 to accept input of login information, such as a user ID, from the user. Then, the client application 13 transmits the accepted login information to the server program 23 to request login authentication (C02). The server program 23 authenticates the login based on user information stored in the user database 24. If the user is already logged in prior to this posting procedure, the client application 13 skips C01 and C02.

Upon successful login, the client application 13 transmits an instruction to start posting to the server 22, attaching label data to be posted (C11). In other words, in C11, client application 13 uploads the label data to be posted to the server 22. C11 is an example of a posting process.

In the posting procedure executed in A12 in FIG. 2, the label data to be posted is the label data edited by the automatic editing process (for example, the label data 80 in FIG. 5B). Specifically, in C11, the client application 13 automatically selects the edited label data and uploads the edited label data to the server 22. The label data to be posted is likely different from the label data that has been printed or saved in A05 in FIG. 2. Since the label data is edited by the automatic editing process, the uploaded label data is unlikely to contain personal information, thereby reducing information leakage.

In response to receiving an instruction to start posting from the client application 13, the server program 23 of the server 22 generates screen data for a posting screen that accepts a posting instruction (C12) and transmits the generated screen data to the client application 13 (C13). The screen data generated in C12 includes an image and a thumbnail image of label data to be posted, that is, an image generated based on the label data transmitted from the client application 13 in C11.

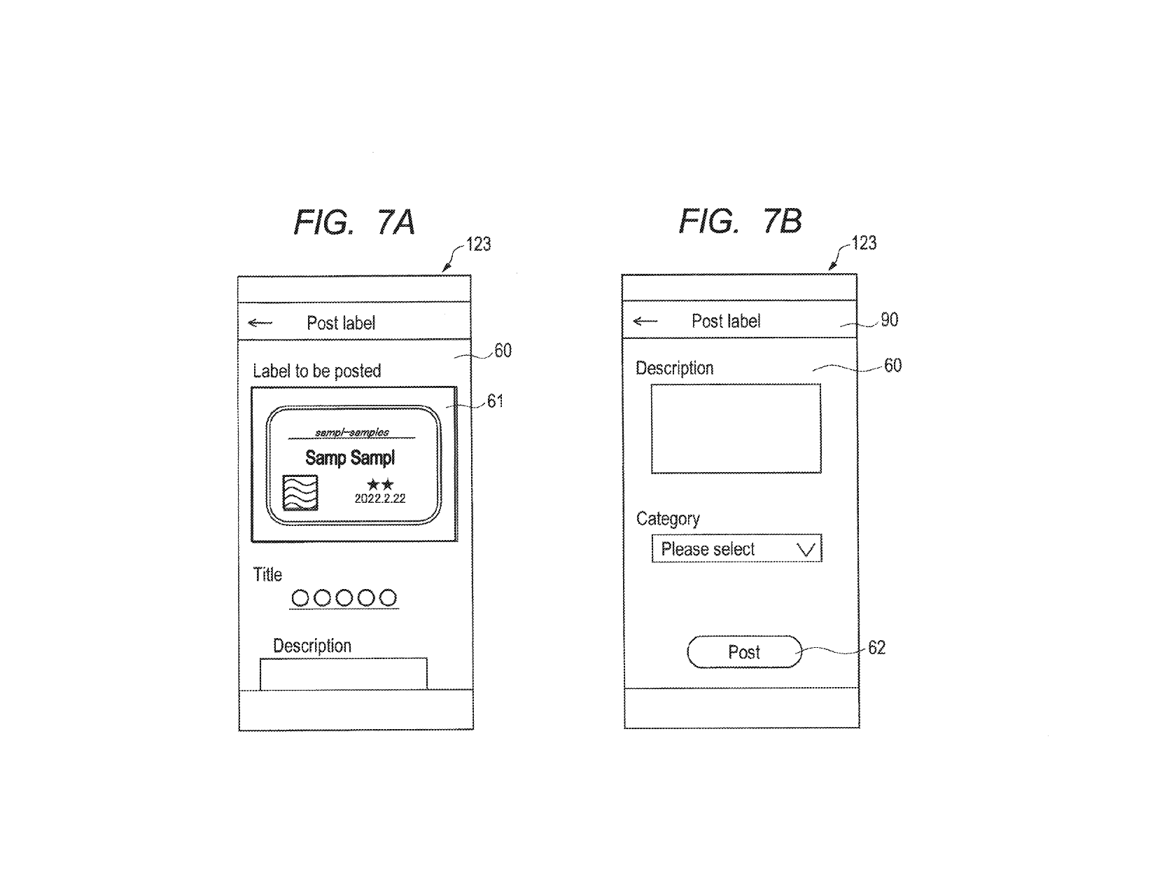

The client application 13 displays a posting screen on the user interface 123 based on the screen data transmitted from the server 22 (C15). For example, as shown in FIG. 7A, a posting screen 60 previews an image of the label data to be posted as a label image 61. After executing the automatic editing process (FIG. 4), the posting screen 60 displays the image of the label data as changed by the automatic editing process. Step C15 is an example of a preview process. The client application 13 may have a browser function or may launch a browser to display the screen.

The server program 23 accepts input of various information on the posting screen 60. The user enters requested information such as the title, description, and category in the input fields of the posting screen 60 (C21). The posting screen 60 displays a plurality of input fields as the user performs scroll operations, as shown in FIG. 7B. In response to accepting an operation on the posting screen 60, the client application 13 transmits information indicating the accepted operation to the server 22 (C22). The server program 23 does not accept input to the label image 61 on the posting screen 60, that is, the user is not allowed to edit label data on the posting screen 60.

The server program 23 displays the content on the posting screen 60 based on input information transmitted from the client application 13. The posting screen 60 includes a posting instruction button 62, as shown in FIG. 7B. The posting instruction button 62 accepts a selection to post the label data. The posting instruction button 62 may be enabled after requested information has been entered.

The posting screen 60 also functions as a screen to accept the user's selection of whether to proceed with the posting. The user is allowed to confirm the automatically edited label data to be posted through the label image 61 displayed on the posting screen 60, thereby preventing unintended postings. In a case where the user wishes to cancel the posting after reviewing the label image 61, the user may close the posting screen 60 without operating the posting instruction button 62. Alternatively, the posting screen 60 may include a button to cancel the posting.

When the user operates the posting instruction button 62 (C23), the client application 13 transmits information indicating that the posting instruction button 62 has been operated to the server 22 (C24). In response to receiving the information indicating that the posting instruction button 62 has been operated, the server program 23 stores (registers) the label data displayed on the posting screen 60 in the label database 25 (C25). Steps C24 and C25 constitute a process of storing (registering) label data in the label database 25 and are an example of a posting process.

The server program 23 stores, in the label database 25, a label ID identifying the label data, a user ID indicating the posting user, and various input information entered on the posting screen 60 in association with the label data. The user ID identifying the posting user is, for example, the user ID of the user who input login information in C01. The server program 23 may notify the client application 13 of completion of registration.

In a case where label data is stored in the label database 25 based on user operations, the changed label data from the automatic editing process is not stored in the memory 122 of the terminal 12. The client application 13 may delete the changed label data from the memory 122 upon transmitting the instruction to start posting in C11 to the server 22. Alternatively, the client application 13 may delete the changed label data from the memory 122 after the posting instruction button 62 is operated in C23 or after the posting screen 60 is closed without operating the posting instruction button 62.

The label data with changed text or image objects resulting from the automatic editing process is intended for posting and is not for use by the posting user. For example, if the changed label data overwrites and saves over the original label data, editing for restoring the original label data may be necessary. The client application 13 does not save the changed label data, thereby preventing inconvenience to the posting user.

Referring to the posting suggestion procedure in FIG. 2, after executing the posting procedure shown in FIG. 6 in A12, the client application 13 terminates the connection with the server 22 and displays a home screen of the client application 13 on the user interface 123 (A13). The home screen is, for example, the screen displayed upon launching the client application 13, and is a screen for accepting selection of a function to be executed by the client application 13. Alternatively, the client application 13 may display an editing screen.

The client application 13 may maintain its connection with the server 22 after completing the posting procedure. The server 22 may display a top screen of the server program 23 on the terminal 12. The server program 23 receives label data from the terminal 12 and store the label data in the label database 25, and also transmits label data stored in the label database 25 to the terminal 12.

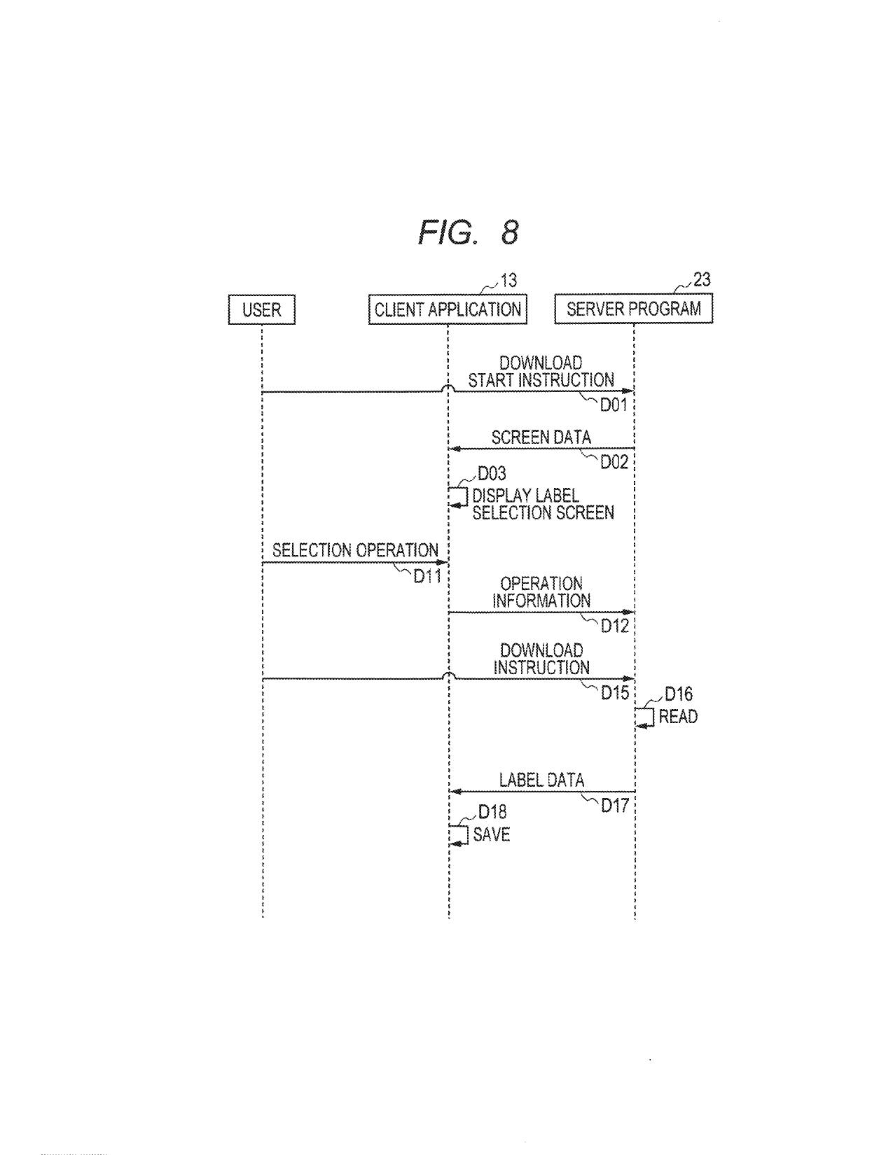

Next, a download procedure is described with reference to the sequence diagram of FIG. 8. The download procedure is a procedure for transmitting label data stored in the label database 25 to the terminal 12. This procedure is executable, for example, after the client application 13 starts to be executed on the terminal 12, connects to the server 22, accepts an instruction to use the server program 23, and the connection with the server 22 is established. In response to accepting a connection instruction from the client application 13, the server program 23 transmits screen data for displaying a top screen, for example, to the terminal 12. The user issues a download start instruction to the server 22 via the top screen of the server program 23 displayed on the terminal 12. The download procedure may be executed consecutively after the posting procedure described above.

In response to accepting the download start instruction from the user (D01), the server program 23 transmits screen data for a label selection screen, which allows the user to select label data for download, to the terminal 12 (D02). The server 22 may request the user to log in if the user is not already logged in.

The client application 13 displays the label selection screen on the user interface 123 based on the screen data transmitted from the server 22 (D03). The label selection screen includes, for example, images of a plurality of downloadable label data and accepts user selections. In response to accepting a user's operation on the displayed label selection screen (D11), the client application 13 transmits the accepted operation information to the server program 23 (D12).

In the label selection screen, label data stored in the label database 25 through the posting procedure described above (FIG. 6) are displayed in a selectable manner. The terminal 12 that transmits label data to the server 22 via the posting procedure (FIG. 6) is an example of a first information processing apparatus. The terminal 12 that selects and downloads label data stored in the label database 25 is an example of a second information processing apparatus.

The user selects label data for download and inputs a download instruction (D15). The download instruction is an instruction to instruct the terminal 12 to download the selected label data. The server program 23 reads, from the label database 25, the label data selected by the user's operation (D16), and transmits the read label data to the terminal 12 (D17). The client application 13 stores the label data received from the server 22 in the memory 122 (D18).

Thus, the user who issues the download instruction reads and uses the label data stored in the memory 122 via the client application 13. The system 100 enables label data sharing among a plurality of terminals 12. For example, in a case where the selected label data for download has undergone the automatic editing process on the terminal of the posting user, the text and image objects are replaced with dummy data. Therefore, the likelihood of including personal information from the posting user is reduced. The downloading user edits the dummy data to suit their needs, facilitating easier use of the downloaded label data.

Referring to the posting suggestion procedure in FIG. 2, in response to accepting an operation on the button 51 in the posting suggestion dialog 50 shown in FIG. 3C (alt: [Post as is]), the client application 13 executes the posting procedure (A21) without performing the automatic editing process. The posting procedure in A21 is the same as the posting procedure in A12 shown in FIG. 6. The operation on the button 51 serves as an instruction to post label data without changing the content of particular objects included in the label data of the suggestion target.

In the posting procedure in A21, the client application 13 transmits the printed or saved label data (for example, the label data 70 in FIG. 5A) to the server program 23. In this case, the label data to be posted is the original, unedited version of the label data. The user may wish to share label data as is even if the label data contains personal information such as store names. In that case, pressing the button 51 automatically transitions to the posting screen, which provides high flexibility in posting. After the posting procedure in A21, the client application 13 displays the home screen as the same as the home screen at launch (A22). The client application 13 may display the editing screen or maintain connection with the server 22 to display the top screen of the server program 23.

In the posting suggestion dialog 50 shown in FIG. 3C, when the button 53 (alt: "Do not post") is operated, the client application 13 closes the posting suggestion dialog 50 without performing the posting procedure. As a result, the editing screen 30 is displayed on the user interface 123 again (A31).

The posting suggestion dialog 50 may also include a button that allows manual editing before posting. When this button is operated, the client application 13 may store that the label data is to be edited and display an editing screen. By accepting manual editing of the label data to be suggested, for example, the user is allowed to change portions of text objects within the label data that the user does not wish to disclose before inputting the posting instruction.

In response to accepting an instruction to manually edit and post, the client application 13 may automatically execute the posting procedure using the edited label data as the posting target. The button 53 for accepting an instruction not to post may also serve as a button for accepting an instruction of manual edit and post. Since an instruction to edit the label data to be suggested is accepted based on the instruction not to post, posting of label data by the user is facilitated.

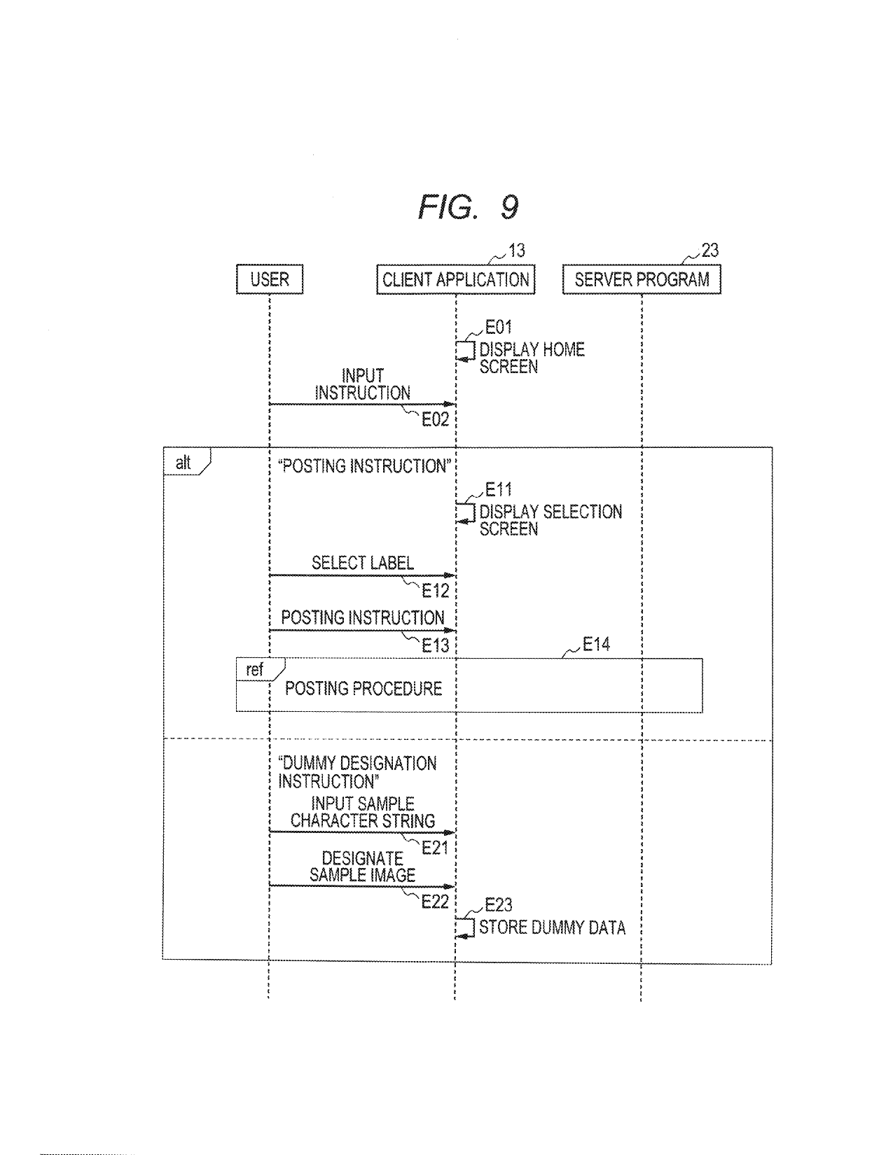

The client application 13 accepts various instructions besides label data editing instructions. For example, the client application 13 accepts a user's operation on the home screen displayed on the user interface 123 of the terminal 12, as shown in A13 and A22 of FIG. 2. The procedure for processing various instructions entered by user operations is described with reference to the sequence diagram of FIG. 9.

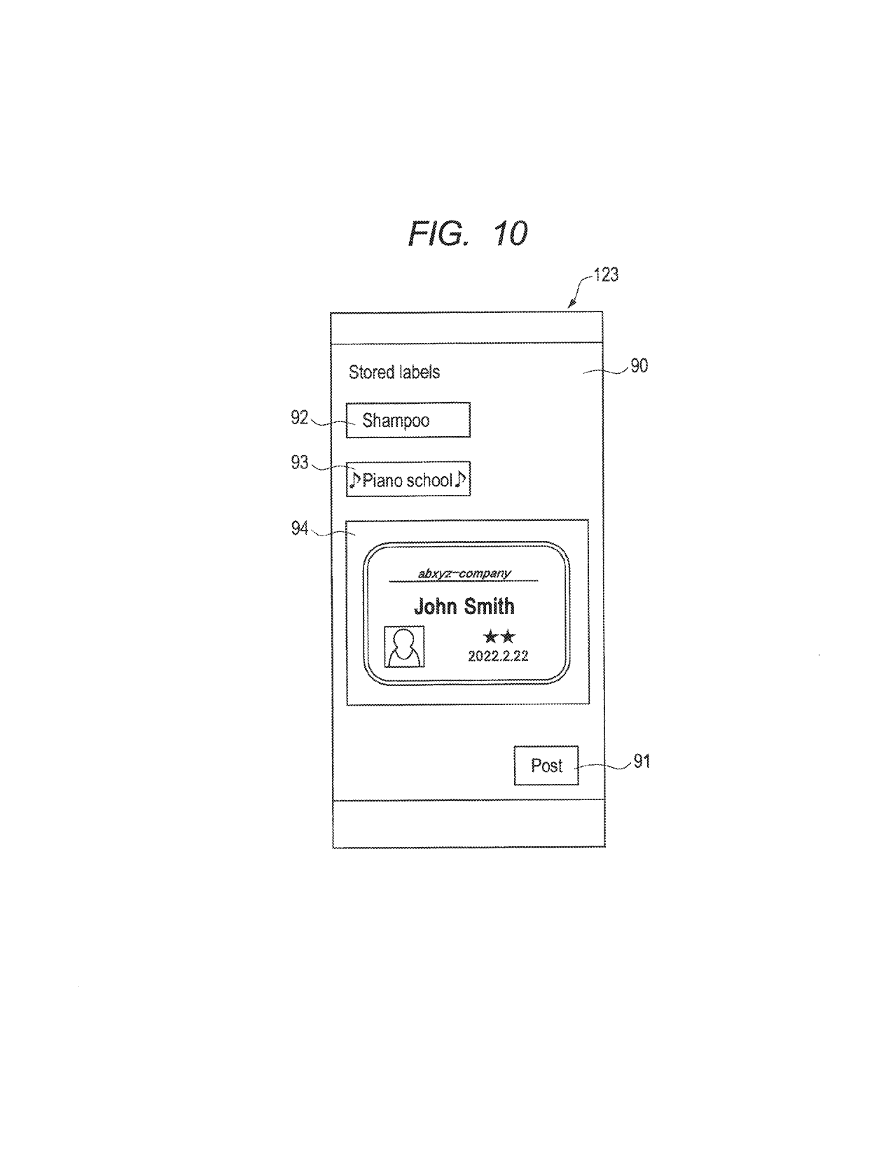

The client application 13 displays the home screen (E01) and accepts a user's instruction (E02). In a case where the accepted instruction is an instruction to post label data (alt: [Posting instruction]), the client application 13 displays a selection screen for selecting the label data to be posted on the user interface 123 (E11). For example, as shown in FIG. 10, a selection screen 90 is a screen including a post button 91 and images 92, 93, 94 of respective label data stored in the memory 122, and accepting user operations.

The user selects label data to be posted by operating one of the images 92, 93, or 94 displayed on the selection screen 90 (E12), and instructs posting by operating the post button 91 (E13). This causes the posting procedure described above to be executed (FIG. 6) (E14), and the label data selected by the user is uploaded to the server 22.

In this case, the user determines the label data to be posted by operating the selection screen 90. In a case where the posting procedure is executed based on a selection made through the posting suggestion dialog 50, the label data to be posted is already determined to be the label data for which printing or saving has been instructed in the editing screen. Since the label data to be posted is already determined, the client application 13 starts the posting procedure without displaying the selection screen 90. This eliminates the user's effort to select label data, facilitating easier posting of label data.

The client application 13 may accept designation of dummy data that is usable for the automatic editing process. That is, the client application 13 may accept designation of sample character strings or sample images as dummy data (that is, user-defined dummy data), and use the user-defined dummy data to generate dummy text in B04 or dummy images in B13 in the automatic editing process described above (FIG. 4). When the user instruction accepted on the home screen displayed in E01 is a dummy data designation instruction (alt: [Dummy designation instruction]), the client application 13 accepts designation of dummy data.

Specifically, the client application 13 accepts input of a sample character string (E21) and designation of a sample image (E22), and stores the accepted data as dummy data in the memory 122 (E23). Step E23 is an example of a storage process. When dummy data is stored in the memory 122, the client application 13 reads the dummy data in B04 or B13 in the automatic editing process (FIG. 4) to generate dummy text or dummy images. The client application 13 may accept dummy data registration by the object type or by the category of label data. Either E21 or E22 may be omitted.

When dummy data is stored in the memory 122, the client application 13 uses the dummy data in the automatic editing process. Accordingly, the contents of text objects and image objects are automatically replaced with the dummy data specified by the user. For example, in a case where a logo for advertisement is stored as a sample image, a photo of user's face is automatically replaced with the logo, enabling easy posting of label data that excludes personal information and includes content for advertisement.

The above description relates to the procedure in which the client application 13 executes the automatic editing process. However, the server program 23 on the server 22 may perform the automatic editing process instead of the client application 13. In this case, the procedure differs in the case where the "Auto edit and post" button 52 is selected in the displayed posting suggestion dialog 50 (A08, FIG. 3C). The other procedures remain the same as the posting suggestion procedure shown in FIG. 2.

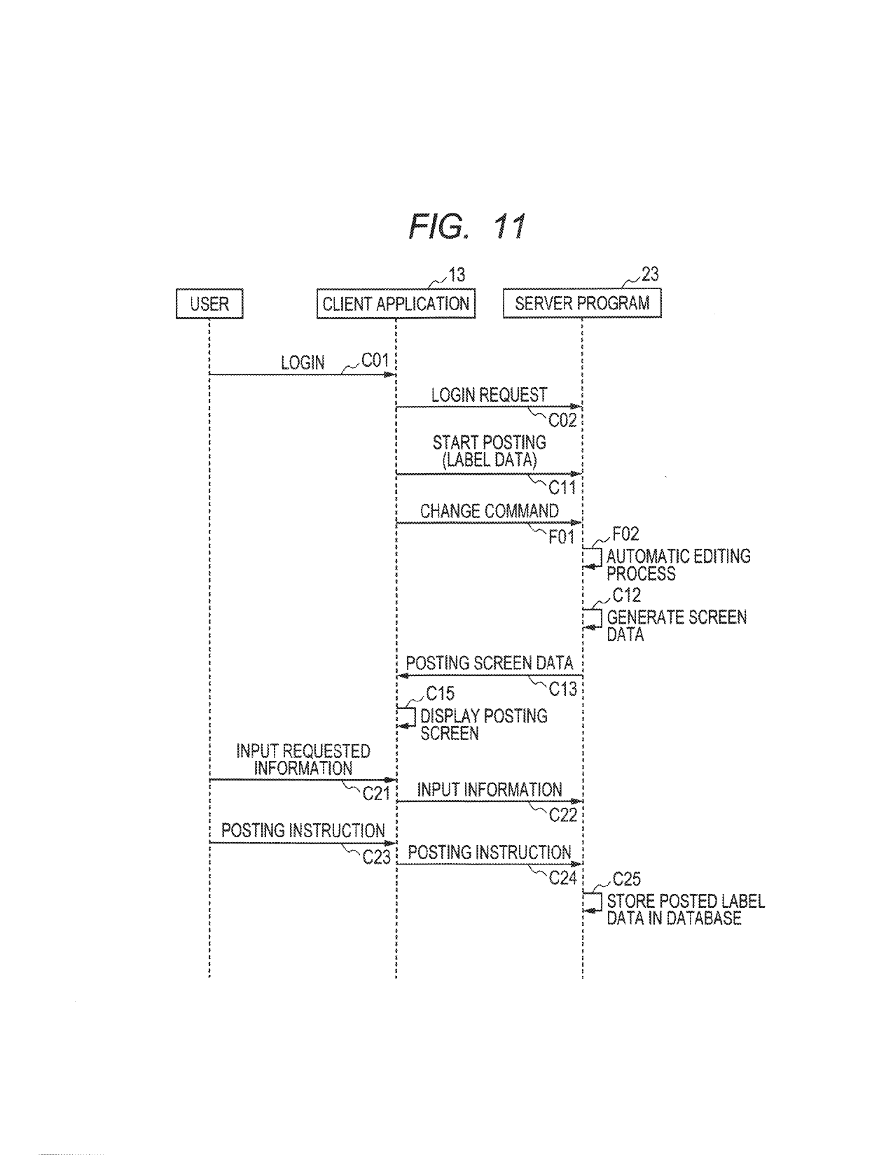

When the server program 23 executes the automatic editing process and accepts an operation on the button 52 (alt: [Auto edit and post]), as shown in the sequence diagram of FIG. 11, the client application 13 first establishes a connection with the server 22. Note that the sequence of steps to display the posting screen in FIG. 11 differs from the posting procedure shown in FIG. 6. Steps identical to those in FIG. 6 are denoted by the same reference numerals and are not described herein.

In this case, the client application 13 does not perform the automatic editing process. Instead, the client application 13 transmits an instruction to start posting to the server 22, designating the label data printed or saved on the editing screen 30 (FIG. 3A) as the label data to be posted (C11). The client application 13 then transmits a change command to the server 22, indicating that an automatic editing process is instructed, in association with the posting start instruction transmitted in C11 (F01). Alternatively, the client application 13 may transmit the change command together with the posting start instruction in C11.

In response to receiving the change command associated with the posting start instruction, the server program 23 executes the automatic editing process shown in FIG. 4 on the label data associated with the change command (F02). Specifically, the server program 23 replaces the content of text and image objects in the received label data with dummy content generated using sample character strings and sample images.

The server program 23 generates screen data for the posting screen, including the image of the changed label data (C12), and transmits the screen data to the terminal 12 (C13). Thus, the label data for posting automatically contains text and image objects replaced with dummy content. The user confirms the changed label data for posting on the posting screen displayed on the terminal 12 (C15).

The server program 23 may accept an instruction for automatic editing after displaying the posting screen on the terminal 12. In this case, the server program 23 may cause the terminal 12 to display the posting screen, which includes the image of the unchanged label data received in C11 and a button for accepting an instruction for automatic editing. When a user operation on the button for automatic editing is accepted on the posting screen, the server program 23 executes the automatic editing process and causes the terminal 12 to display the posting screen including the image of the changed label data. In this case, the instruction for automatic editing is an example of a change command.

In a case where the server 22 executes the automatic editing process, the client application 13 may not include the automatic editing function, and the size of the client application 13 is reduced. In a case where the client application 13 executes the automatic editing process, the load on the server 22 is reduced. Additionally, in a case where the client application 13 executes the automatic editing process, individual and flexible editing may be performed, such as accepting registration of dummy data (for example, user-defined dummy data). In either case, users do not need to edit label data, increasing the likelihood that label data without personal information are posted and stored.

As described in detail above, the client application 13 displays the posting suggestion dialog 50 when a print or save instruction is accepted on the editing screen 30. The printed or saved label data is likely to be label data on which editing is completed (finalized). The client application 13 suggests posting the label data in response to saving or printing, thereby encouraging the user to post the label data. Thus, the user is expected to post the label data.

While the disclosure has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the disclosure, and not limiting the disclosure. Various changes may be made without departing from the spirit and scope of the disclosure. Thus, the disclosure is intended to embrace all known or later developed alternatives, modifications, variations, improvements, and/or substantial equivalents. Some specific examples of potential alternatives, modifications, or variations in the described disclosure are provided below.

For example, the printing method of the label printer 11 is not limited to thermal transfer and may include inkjet, electrophotographic, or thermal printing methods. Similarly, the printing medium is not limited to label sheet and may include roll or fanfold plain paper, or cut sheets, for example.

The display screens shown in the drawings are examples, and the wording, information layout, and button shapes are not limited to those illustrated. The automatic editing process is optional. For example, the posting suggestion dialog 50 may accept a selection of whether to post label data. The client application 13 may display an image of the label data to be posted on the terminal 12 before transmitting the posting start instruction to the server 22.

In the embodiment, the editing screen 30 (FIG. 3A) accepts print and save instructions for label data edited in the editing screen 30. The client application 13 may also accept print instructions for the label data 14 stored in the memory 122. In response to accepting a print instruction for the label data 14 stored in the memory 122, the client application 13 may display the posting suggestion dialog 50 to suggest posting.

In the embodiment, the client application 13 changes both text and image objects during the automatic editing process. Alternatively, the client application 13 may change either text objects or image objects. The client application 13 may change other object types. For example, the client application 13 may accept settings specifying which object types to change, when registering dummy data, for example. Registration of dummy data may be omitted. That is, the user-defined dummy data may not be used.

In the embodiment, the client application 13 may match all of font type, font size, the number of characters, and language of the dummy text to the original label data during the automatic editing process. Alternatively, the client application 13 may match at least one of these attributes, or may match none of these attributes. The client application 13 may also replace the text object area of the original label data with an image object of a dummy image. However, generating dummy text close to the original text object helps preserve the impression of the label data to be posted.

In the embodiment, when the client application 13 accepts a user selection not to post via an operation of the button 53 in the posting suggestion dialog 50 (FIG. 3C), the client application 13 returns to the editing screen 30 (A31). Alternatively, the client application 13 may return to the home screen.

In the embodiment, the client application 13 does not save the edited label data in the memory 122 after the automatic editing process. Alternatively, the client application 13 may accept a save instruction.

The client application 13 may store the label data in the memory 122 in association with information indicating whether the label data has been posted. In this case, when the client application 13 accepts a print instruction for label data associated with information indicating that the label data has already been posted, the client application 13 may avoid suggesting posting. Further, when the client application 13 suggests posting of label data, the client application 13 may store information indicating that posting has been suggested or information indicating the number of suggestions in association with the label data, and the client application 13 may avoid suggesting posting for label data for which posting has been suggested a particular number of times or more.

In any flowchart disclosed in the embodiments, a plurality of processes in any plurality of steps may be performed in any order or in parallel, provided that no contradictions arise in the processing.

The processes disclosed in the embodiments may be executed by a single CPU, a plurality of CPUs, hardware such as ASICs, or any combination of these elements. These processes may also be implemented in various forms, including a storage medium storing a program for executing the processes, or a method of performing the processes.

What is claimed is:

1. A non-transitory computer-readable storage medium storing a set of program instructions for an information processing apparatus comprising a controller and a memory, the set of program instructions, when executed by the controller, causing the information processing apparatus to perform:
editing label data, the label data being printable by a label printer;
storing the edited label data in the memory;
controlling the label printer to perform printing based on the edited label data or the stored label data;
in response to storing the label data or performing printing based on the label data, suggesting posting of the stored label data or the printed label data; and
posting the label data, the posting the label data including uploading the label data to a server, and the server being configured to store the uploaded label data.

2. The non-transitory computer-readable storage medium according to claim 1, wherein the suggesting includes suggesting posting of the stored label data or the printed label data, and accepting selection of whether to post the suggested label data; and
wherein the set of program instructions, when executed by the controller, causes the information processing apparatus to perform:
in response to accepting an instruction to post the suggested label data, posting the suggested label data.

3. The non-transitory computer-readable storage medium according to claim 2, wherein the set of program instructions, when executed by the controller, causes the information processing apparatus to perform:
displaying a selection screen configured to accept selection of label data to be posted, and after the label data to be posted is selected via the selection screen, posting the selected label data; and
in response to accepting the instruction to post the suggested label data, posting the suggested label data without displaying the selection screen.

4. The non-transitory computer-readable storage medium according to claim 1, wherein the set of program instructions, when executed by the controller, causes the information processing apparatus to perform:
changing a particular object included in the label data to be posted into a particular content, the particular object being an editable object; and
posting the label data in which the particular object is changed, and the posted label data being stored in the server.

5. The non-transitory computer-readable storage medium according to claim 4, wherein the changing the particular object includes extracting the particular object included in the label data to be posted, and changing the extracted particular object into the particular content; and
wherein the posting includes, in response to changing the extracted particular object into the particular content, uploading, to the server, the label data in which the particular object is changed into the particular content.

6. The non-transitory computer-readable storage medium according to claim 5, wherein the set of program instructions, when executed by the controller, causes the information processing apparatus to perform:
accepting input of dummy data indicating the particular content; and
storing the accepted dummy data; and
wherein the changing the particular object includes:
extracting the particular object included in the label data to be posted; and
replacing the extracted particular object with the stored dummy data.

7. The non-transitory computer-readable storage medium according to claim 4, wherein the changing the particular object includes transmitting, to the server, a change command in association with the label data to be posted, and the server having received the change command changes the particular object included in the uploaded label data into the particular content.

8. The non-transitory computer-readable storage medium according to claim 4, wherein the suggesting includes suggesting posting of the stored label data or the printed label data, and accepting selection of whether to post the suggested label data after changing the particular object included in the suggested label data into the particular content, to post the suggested label data without changing into the particular content, or not to post the suggested label data; and
wherein the set of program instructions, when executed by the controller, causes the information processing apparatus to perform:
in response to accepting selection to post the suggested label data after changing the particular object into the particular content, changing the particular object into the particular content and posting the suggested label data, and the label data in which the particular object is changed being stored in the server; and
in response to accepting selection to post the suggested label data without changing into the particular content, posting the suggested label data without changing the particular object into the particular content, and the label data in which the particular object is not changed being stored in the server.

9. The non-transitory computer-readable storage medium according to claim 8, wherein the set of program instructions, when executed by the controller, causes the information processing apparatus to perform:
in response to accepting selection not to post the suggested label data, allow editing of the suggested label data.

10. The non-transitory computer-readable storage medium according to claim 4, wherein the particular object is a text object, text indicated in the text object being changed into a particular text indicating the particular content.

11. The non-transitory computer-readable storage medium according to claim 10, wherein the text indicated in the text object is changed into text having a same number of characters as a number of characters before change.

12. The non-transitory computer-readable storage medium according to claim 10, wherein the text indicated in the text object is changed into text having a same font size as a font size before change.

13. The non-transitory computer-readable storage medium according to claim 10, wherein the text indicated in the text object is changed into text having a same font type as a font type before change.

14. The non-transitory computer-readable storage medium according to claim 10, wherein the text indicated in the text object is changed into text of a same language as a language before change.

15. The non-transitory computer-readable storage medium according to claim 4, wherein the particular object is an image object, and an image set as the image object is changed into a particular image indicating the particular content.

16. The non-transitory computer-readable storage medium according to claim 15, wherein the changing the image object includes adjusting the particular image to be an image size before change, and setting the adjusted particular image to an image of the image object after change.

17. The non-transitory computer-readable storage medium according to claim 4, wherein the set of program instructions, when executed by the controller, causes the information processing apparatus to perform:
after changing the particular object and before storing the changed label data in the server, displaying a preview of the changed label data, the displaying the preview allowing selection of whether to post the changed label data; and
in response to accepting selection to post the changed label data, transmitting the changed label data to the server, and the changed label data being stored in the server.

18. The non-transitory computer-readable storage medium according to claim 4, wherein the set of program instructions, when executed by the controller, causes the information processing apparatus to perform:
in a case where the changed label data is stored in the server, not storing the changed label data in the information processing apparatus.

19. An information processing apparatus comprising:
a memory;
a communication interface; and
a controller configured to perform:
editing label data, the label data being printable by a label printer;
storing the edited label data in the memory;
controlling the label printer to perform printing based on the edited label data or the stored label data;
in response to storing the label data or performing printing based on the label data, suggesting posting of the stored label data or the printed label data; and
posting the label data, the posting the label data including uploading the label data to a server via the communication interface, and the server being configured to store the uploaded label data.

20. A label data sharing system comprising a first information processing apparatus, a second information processing apparatus, and a server, the first information processing apparatus and the second information processing apparatus being connectable to the server via a network,
the first information processing apparatus configured to:
edit label data, the label data being printable by a label printer;
store the edited label data;
control the label printer to perform printing based on the edited label data or the stored label data;
in response to storing the label data or performing printing based on the label data, suggest posting of the stored label data or the printed label data; and
upload the label data to a server;
the server configured to store the uploaded label data; and
the second information processing apparatus configured to:
select one of a plurality of label data stored in the server; and
in response to accepting an instruction to download selected label data, download the selected label data from the server.
